(19) United States
(12) Patent Application Publication
(10) Pub. No.: US 2026/0177778 A1
(43) Pub. Date: Jun. 25, 2026

(54) LENS DEVICE

(71) Applicant: FUJIFILM Corporation, Tokyo (JP)

(72) Inventor: Mitsuhiko OKA, Saitama (JP)

(73) Assignee: FUJIFILM Corporation, Tokyo (JP)

(21) Appl. No.: 19/403,290

(22) Filed: Nov. 28, 2025

(30) Foreign Application Priority Data
Dec. 24, 2024 (JP) 2024-227980

(51) Int. Cl. G02B 7/04

(52) U.S. Cl. CPC G02B 7/04

(57) ABSTRACT

A lens device includes: an operation ring that rotates in a direction around an optical axis; a click mechanism that imparts a click feeling to the rotation of the operation ring; an operation member that moves along a direction of the optical axis; and a switching member that switches a mode of the click feeling imparted by the click mechanism by rotating in the direction around the optical axis in conjunction with the movement of the operation member.

### CROSS-REFERENCE TO RELATED APPLICATIONS

This application claims priority under 35 USC 119 from Japanese Patent Application No. 2024-227980 filed on Dec. 24, 2024, the disclosure of which is incorporated by reference herein.

### BACKGROUND OF THE INVENTION

### 1. Field of the Invention

The technology of the present disclosure relates to a lens device.

### 2. Description of the Related Art

JP2020-129046A discloses a lens barrel including: a changeover switch; a switch base fixed to the changeover switch; a rotatable cylindrical ring member; and a retaining spring fixed to a fixed cylinder, in which the ring member has an uneven portion along a circumferential direction of an inner peripheral portion and a flat portion adjacent to the uneven portion, the switch base has a through hole, and a biasing member having one end in contact with a spherical member and the other end in contact with the retaining spring is inserted into the through hole.

JP2021-135303A discloses a click locking mechanism including a plurality of locking portions that are intermittently disposed along a first direction on a first member of two members adjacent to each other and relatively movable in the first direction and that are attracted to each other by magnetic force, a magnet that is disposed at a position that faces each of the locking portions and that is non-contact with the locking portions on a second member side of the two members, a switch member that is disposed on the second member so as to be movable between an on position and an off position, and a magnetic field generating structure configured to generate, by a magnetic field of the magnet, a restricting magnetic field that restricts the movement of the locking portion facing the magnet in the first direction in a case where the switch member is at the on position and to not generate the restricting magnetic field in a case where the switch member is at the off position.

JP2015-169786A discloses a stop device of an interchangeable lens including a stop ring mounted so as to rotationally move relative to a fixed cylinder portion of a lens barrel and configured to adjust a stop and a click mechanism portion that is capable of click-engaging the stop ring at positions corresponding to a plurality of F numbers, the stop device comprising: the stop ring disposed on an outer peripheral surface located in the vicinity of a rear end of the fixed cylinder portion on an image formation side of the fixed cylinder portion; the click mechanism portion in which an engaging portion having an engaging body pressed against the stop ring by being elastically supported by an elastic portion is disposed on the fixed cylinder portion, and a plurality of engaged portions with which the engaging body engages at the positions corresponding to the F numbers during rotational movement are formed on the stop ring; an operation mechanism portion having an operation part disposed on a rear end surface of the fixed cylinder portion; a release mechanism portion configured to release the pressure of the engaging body against the stop ring based on a predetermined displacement amount; and a transmission mechanism portion that transmits the displacement amount based on the operation of the operation part to the release mechanism portion.

JP2013-134425A discloses a stop device of a lens including a stop ring mounted so as to rotationally move relative to a fixed cylinder portion of a lens barrel and configured to adjust a stop and a click mechanism portion that is capable of click-engaging the stop ring at positions corresponding to a plurality of F numbers, the stop device comprising: a click mechanism portion in which an engaging portion having an engaging body that is elastically supported is disposed on one of the fixed cylinder portion and the stop ring, and an engaged base portion having an engaged surface against which the engaging body is pressed and in which a plurality of engaged portions, with which the engaging body is engageable at positions corresponding to F numbers in a case where the stop ring is rotationally moved, are formed, is provided on the other; and a mode switching mechanism portion configured to switch between a click mode in which the engaging body and the engaged surface are pressed together and a non-click mode in which the engaging body and the engaged surface are separated and the click function is released by changing a position of at least one of the engaging portion or the engaged base portion.

WO2016/039294A discloses a lens barrel that has a stop portion of which an opening diameter is changeable, a fixed cylinder portion that accommodates the stop portion, and a stop ring that is attached to the fixed cylinder portion so as to be rotationally movable and is configured to adjust the opening diameter of the stop portion, the lens barrel comprising: in a case in which a portion of the stop ring facing the fixed cylinder portion or a portion of the fixed cylinder portion facing the stop ring is a “first facing part” and a portion of the fixed cylinder portion facing the first facing part or a portion of the stop ring is a “second facing part”, first and second protrusion portions that are located at two positions along a circumferential direction of the stop portion so as to be biased from the stop portion toward the stop ring; a fitting portion that is formed on a side of the stop ring such that the first and second protrusion portions are alternatively fitted thereinto according to a rotational movement position of the stop ring, and the stop ring is integrally rotationally moved with the stop portion; a link releasing portion that is configured to release the first and second protrusion portions from the fitting portion so that the stop ring is rotationally moved in a state of being separated from the stop portion; and a click mechanism that is formed or disposed at the first facing part and the second facing part so as to give a click feeling to the rotational movement of the stop ring, in which the click mechanism has a click spring member attached to the first facing part, a locking member biased toward the second facing part by the click spring member, and a locked portion formed or disposed on a second facing part side so as to lock the locking member, the second facing part has a locked surface having a plurality of locked portions in the circumferential direction, and a substantially flat surface having no locked portion, and in a case in which the stop ring is rotationally moved with the first protrusion fitted into the fitting portion, the locking member slides on the locked surface, and in a case in which the stop ring is rotationally moved with the second protrusion portion fitted into the fitting portion, the locking member slides on the substantially flat surface.

### SUMMARY OF THE INVENTION

One embodiment according to the technology of the present disclosure provides a lens device that can be reduced in size in an optical axis direction as compared with the related art.

According to a first aspect according to the technology of the present disclosure, there is provided a lens device comprising: an operation ring that rotates in a direction around an optical axis; a click mechanism that imparts a click feeling to the rotation of the operation ring; an operation member that moves along a direction of the optical axis; and a switching member that switches a mode of the click feeling imparted by the click mechanism by rotating in the direction around the optical axis in conjunction with the movement of the operation member.

According to a second aspect according to the technology of the present disclosure, the lens device according to the first aspect further comprises: a first member that is coupled to the operation member and that moves along the direction of the optical axis; a second member that is coupled to the first member and that converts the movement of the first member into a rotational motion; and a third member that is coupled to the second member and that moves along the direction around the optical axis in conjunction with the rotational motion of the second member, in which the switching member is coupled to the third member.

According to a third aspect according to the technology of the present disclosure, in the lens device according to the second aspect, the second member includes a rotation center portion serving as a center of rotation of the second member, a first coupling portion that is coupled to the first member, and a second coupling portion that is coupled to the third member, and a first distance that is a distance between the rotation center portion and the first coupling portion is shorter than a second distance that is a distance between the rotation center portion and the second coupling portion.

According to a fourth aspect according to the technology of the present disclosure, in the lens device according to the third aspect, both a first stroke angle that is a stroke angle of the first coupling portion about the rotation center portion and a second stroke angle that is a stroke angle of the second coupling portion about the rotation center portion are acute angles.

According to a fifth aspect according to the technology of the present disclosure, in the lens device according to the third or fourth aspect, the second member includes a first arm portion that extends from the rotation center portion toward the first coupling portion, and a second arm portion that extends from the rotation center portion toward the second coupling portion.

According to a sixth aspect according to the technology of the present disclosure, the lens device according to any one of the second to fifth aspects further comprises: a switch assembly, in which the switch assembly includes the operation member, the first member, the second member, and the third member.

According to a seventh aspect according to the technology of the present disclosure, in the lens device according to the sixth aspect, the second member includes a rotation center portion serving as a center of rotation of the second member, the switch assembly includes a support portion that rotatably supports the second member, the support portion includes a base portion that supports the second member, and an engaging portion formed on a top surface of the base portion and engaged with the rotation center portion, and a part of an outer peripheral surface of the base portion forms a part of a first sliding surface on which the first member slides.

According to an eighth aspect according to the technology of the present disclosure, in the lens device according to the sixth or seventh aspect, the switch assembly includes a first sliding surface on which the first member slides, and a second sliding surface on which the third member slides, and the first sliding surface and the second sliding surface are integrally formed.

According to a ninth aspect according to the technology of the present disclosure, in the lens device according to the eighth aspect, the first member includes a first protrusion portion that slides on the first sliding surface, and the third member includes a second protrusion portion that slides on the second sliding surface.

According to a tenth aspect according to the technology of the present disclosure, in the lens device according to any one of the sixth to ninth aspects, the switch assembly includes a cover that accommodates the first member, the second member, and the third member.

According to an eleventh aspect according to the technology of the present disclosure, in the lens device according to any one of the first to tenth aspects, the operation ring is a stop ring.

According to a twelfth aspect according to the technology of the present disclosure, in the lens device according to any one of the first to eleventh aspects, the click mechanism includes a plurality of recessed portions that are formed on a first surface of the operation ring and that are arranged in the direction around the optical axis, a protruding member that faces the first surface, and a biasing member that biases the protruding member to a first surface side, and the switching member includes an opening for selectively fitting the protruding member into the plurality of recessed portions in a case where a position of the operation member is a first position, and an intervening portion that is interposed between the first surface and the protruding member in a case where the position of the operation member is a second position.

According to a thirteenth aspect according to the technology of the present disclosure, in the lens device according to the twelfth aspect, the plurality of recessed portions, the protruding member, and the biasing member constitute a locking mechanism that locks the operation ring.

### BRIEF DESCRIPTION OF THE DRAWINGS

FIG. 1 is a side view of a lens device according to an embodiment of the technology of the present disclosure.

FIG. 2 is a perspective view of a stop ring.

FIG. 3 is an exploded perspective view of a rear cover assembly including a switching member, a rear cover, a click mechanism, and a switch assembly.

FIG. 4 is a perspective view of the switching member.

FIG. 5 is an enlarged perspective view of a peripheral portion of an opening in the switching member.

FIG. 6 is a perspective view of the rear cover assembly and is a view showing a first state in which a slide switch is moved to a first movement position.

FIG. 7 is a longitudinal cross-sectional view of an outer barrel-rear cover assembly including an outer barrel, a stop ring, a switching member, a rear cover, and a click mechanism, and is a view showing the first state.

FIG. 8 is an enlarged longitudinal cross-sectional view of a peripheral portion (X portion) of the click mechanism in the outer barrel-rear cover assembly and is a view showing the first state.

FIG. 9 is a perspective view of the rear cover assembly and is a view showing a second state in which the slide switch is moved to a second movement position.

FIG. 10 is a longitudinal cross-sectional view of the outer barrel-rear cover assembly and is a view showing the second state.

FIG. 11 is an enlarged longitudinal cross-sectional view of the peripheral portion (X portion) of the click mechanism in the outer barrel-rear cover assembly and is a view showing the second state.

FIG. 12 is a perspective view of the switch assembly and is a view showing a state in which a case is detached from a cover.

FIG. 13 is a perspective view of the switching member and the switch assembly, in which the cover is not shown.

FIG. 14 is a side view of the slide switch and an interlocking mechanism (viewed in a radial direction of the lens device).

FIG. 15 is a diagram illustrating an operation of the interlocking mechanism in a case of switching from click-on to click-off.

FIG. 16 is a side view of the switch assembly, in which the cover is not shown.

FIG. 17 is an enlarged view of a peripheral portion of the interlocking mechanism of FIG. 16.

FIG. 18 is a side view of the case.

### DESCRIPTION OF THE PREFERRED EMBODIMENTS

Hereinafter, an example of a lens device 10 according to one embodiment of the technology of the present disclosure will be described with reference to the accompanying drawings. In the following description, the description may be made over a plurality of drawings.

### Overall Configuration of Lens Device 10

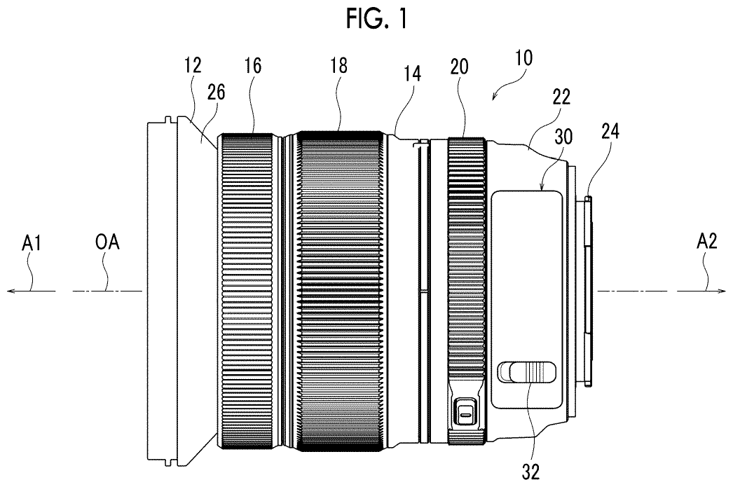

As shown in FIG. 1, the lens device 10 according to the present embodiment is a lens device that can be applied to various cameras such as a digital still camera. A side indicated by an arrow A1 is an object side, and a side indicated by an arrow A2 is an image formation side. The lens device 10 has an optical axis OA. In the following description, a direction of the optical axis OA (hereinafter, referred to as an “optical axis direction”) refers to a direction parallel to the optical axis OA. In addition, a direction around the optical axis OA (hereinafter, referred to as a “direction around the optical axis”) refers to a circumferential direction centered on the optical axis OA.

The lens device 10 comprises a lens hood 12, an outer barrel 14, a focus ring 16, a zoom ring 18, a stop ring 20, a rear cover 22, and a mount 24. The lens hood 12 is disposed on the object side of the outer barrel 14, and the rear cover 22 is disposed on the image formation side of the outer barrel 14. The mount 24 is disposed at an end part of the rear cover 22 on the image formation side.

The lens hood 12 has a hood portion 26. The focus ring 16, the zoom ring 18, and the stop ring 20 are disposed between the hood portion 26 and the rear cover 22. The focus ring 16, the zoom ring 18, and the stop ring 20 are disposed in the order of the focus ring 16, the zoom ring 18, and the stop ring 20 from the object side toward the image formation side.

The focus ring 16, the zoom ring 18, and the stop ring 20 are provided to be rotatable in the direction around the optical axis with respect to the outer barrel 14. Specifically, the focus ring 16, the zoom ring 18, and the stop ring 20 are formed in an annular shape along the direction around the optical axis. The focus ring 16, the zoom ring 18, and the stop ring 20 are disposed on a radially outer side of the outer barrel 14 and are rotatably supported in the direction around the optical axis with respect to the outer barrel 14.

The lens device 10 comprises a plurality of lenses and a stop (all of which are not shown). The plurality of lenses include an objective lens, a focus lens, a zoom lens, and an image formation lens. The focus ring 16 is a member for rotating the focus lens in the optical axis direction. The zoom ring 18 is a member for rotating the zoom lens in the optical axis direction. The stop ring 20 is a member for adjusting a size of an opening of the stop.

### Configuration of Stop Ring 20 and Click Mechanism 98

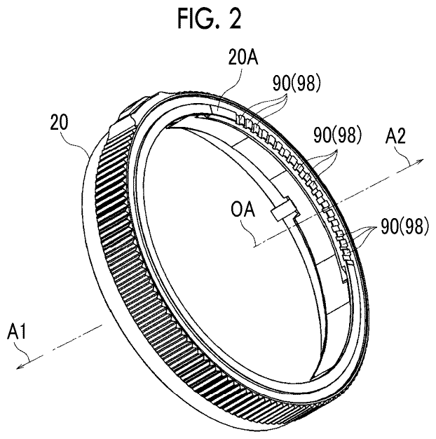

As shown in FIG. 2, a plurality of recessed portions 90 arranged in a rotation direction of the stop ring 20 are formed on an image formation side surface 20A of the stop ring 20. The plurality of recessed portions 90 are all open to the image formation side. The image formation side surface 20A of the stop ring 20 is an example of a “first surface” according to the technology of the present disclosure.

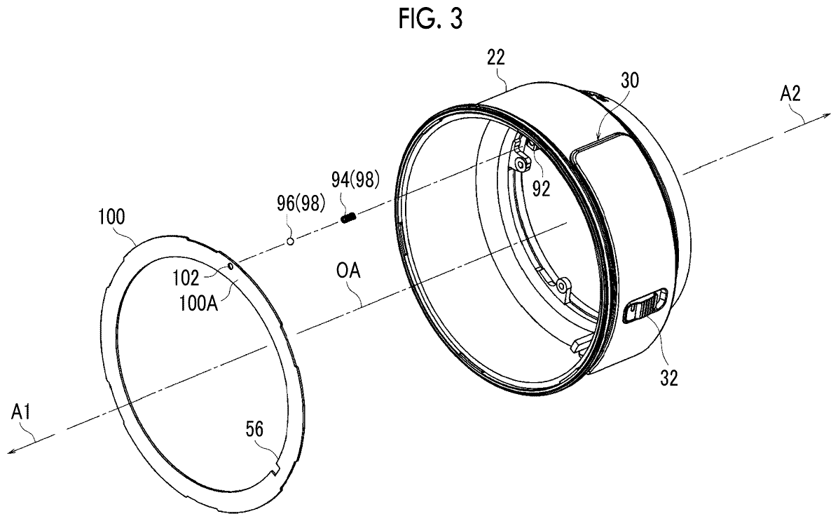

As shown in FIG. 3, a holding portion 92 is formed in the rear cover 22. The holding portion 92 is formed in a cylindrical shape with a direction parallel to the optical axis direction as an axis. A spring 94 is accommodated inside the holding portion 92, and a ball member 96 that is a ball-shaped member is provided on the object side of the spring 94. The spring 94 is, for example, a coil spring. The ball member 96 is biased toward the plurality of recessed portions 90 (that is, the object side) by the spring 94, and is selectively fitted into the plurality of recessed portions 90 in response to the rotation of the stop ring 20.

The ball member 96 is selectively fitted into the plurality of recessed portions 90 in response to the rotation of the stop ring 20, so that a click feeling is obtained with respect to the rotation of the stop ring 20. That is, the plurality of recessed portions 90, the ball member 96, and the spring 94 constitute a click mechanism 98 that imparts a click feeling to the rotation of the stop ring 20. In a state in which the ball member 96 is fitted into any of the plurality of recessed portions 90, the stop ring 20 is locked to the rear cover 22, so that the click mechanism 98 also constitutes a locking mechanism that locks the stop ring 20 to the rear cover 22. The stop ring 20 is an example of an “operation ring” according to the technology of the present disclosure. The ball member 96 is an example of a “protruding member” according to the technology of the present disclosure. The spring 94 is an example of a “biasing member” according to the technology of the present disclosure. The click mechanism 98 is an example of a “click mechanism” and a “locking mechanism” according to the technology of the present disclosure.

The spring 94 may be various springs other than the coil spring. In addition, instead of the spring 94, a biasing member such as a rubber material may be used. In addition, instead of the ball member 96, for example, a protruding member having a shape other than a ball shape may be used.

A switching member 100 is provided on the object side of the rear cover 22. The switching member 100 is formed in an annular shape (for example, a ring shape) along the direction around the optical axis. The switching member 100 is rotatably supported in the direction around the optical axis with respect to the rear cover 22. The switching member 100 is disposed to face the image formation side surface 20A of the stop ring 20. The switching member 100 may be formed in an arc shape along the direction around the optical axis. The switching member 100 is a member that switches the mode of the click feeling imparted by the click mechanism 98 by rotating in the direction around the optical axis in conjunction with the movement of a slide switch 32 described below. Hereinafter, details will be described.

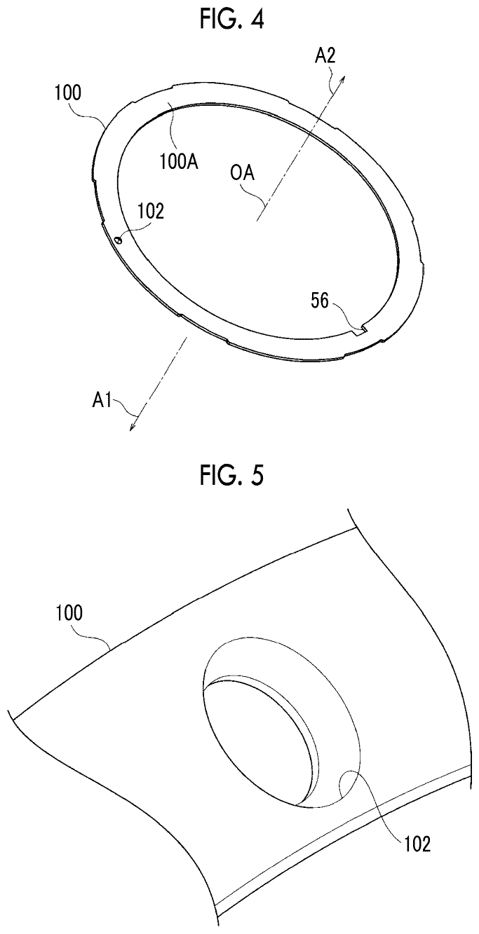

As shown in FIGS. 4 and 5, the switching member 100 has an opening 102 that penetrates in the optical axis direction. The opening 102 is, for example, a through-hole. The opening 102 may be a notch. The opening 102 has a size such that the ball member 96 can be inserted into the opening 102. The opening 102 has a gradient such that a diameter increases toward a side opposite to the image formation side surface 20A of the stop ring 20 (that is, the image formation side).

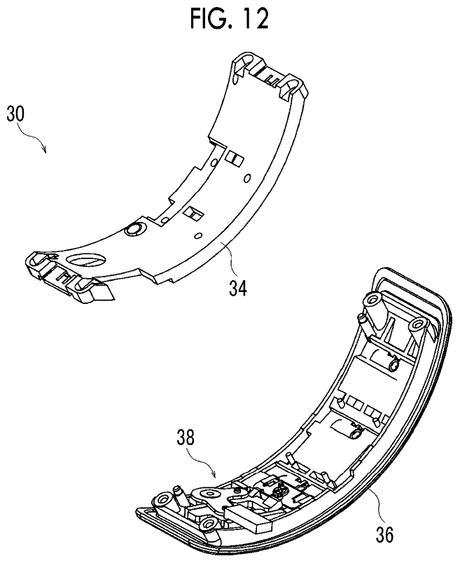

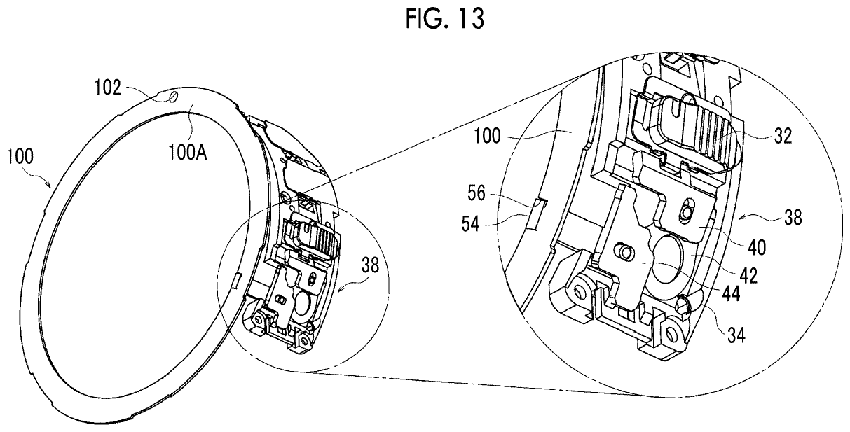

The rear cover 22 is provided with a switch assembly 30. The switch assembly 30 is provided with the slide switch 32. The slide switch 32 is an example of an “operation member” according to the technology of the present disclosure. The switch assembly 30 may be provided with various switches or buttons (not shown) other than the slide switch 32. The slide switch 32 is a member for switching a rotational position of the switching member 100 between a first position and a second position. The slide switch 32 is supported to be movable along the optical axis direction with respect to the switch assembly 30. The slide switch 32 is coupled to the switching member 100 via an interlocking mechanism 38 (see FIGS. 12 to 17) described below. The interlocking mechanism 38 is a mechanism that converts the movement of the slide switch 32 in the optical axis direction into the movement of the switching member 100 in the direction around the optical axis.

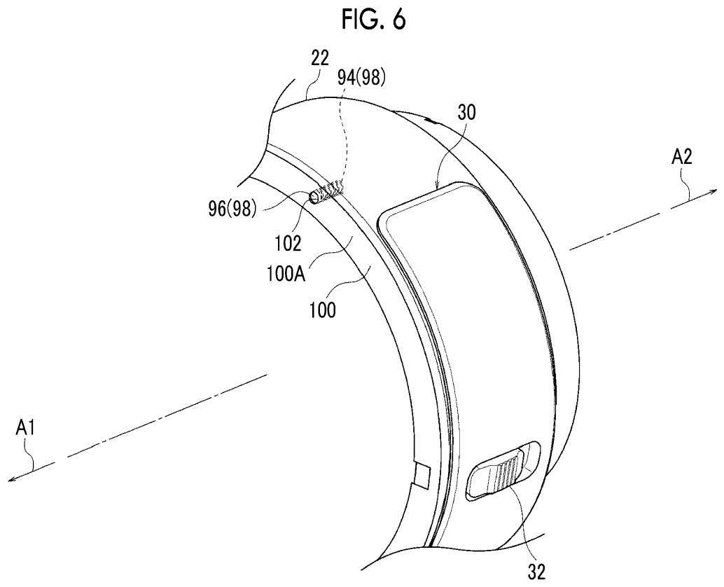

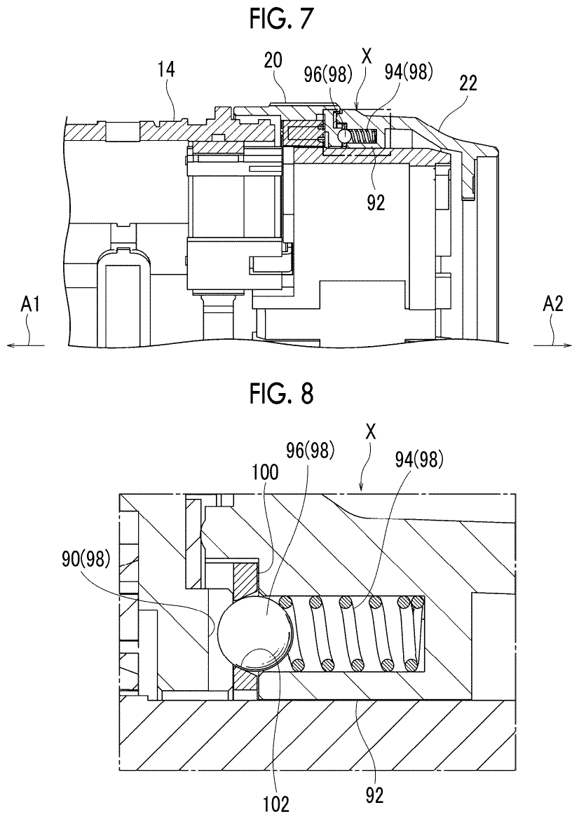

As shown in FIGS. 6 to 8, in a case where the slide switch 32 is moved to a first movement position, the rotational position of the switching member 100 becomes the first position, and the opening 102 is moved to a position corresponding to the ball member 96. In a state in which the opening 102 is moved to the position corresponding to the ball member 96, the ball member 96 is inserted into the opening 102, and a portion of the ball member 96 on the object side protrudes from the opening 102 (hereinafter, referred to as a “first state”). In the first state, the ball member 96 is selectively fitted into the plurality of recessed portions 90 via the opening 102 in response to the rotation of the stop ring 20, so that a click feeling is imparted to the rotation of the stop ring 20.

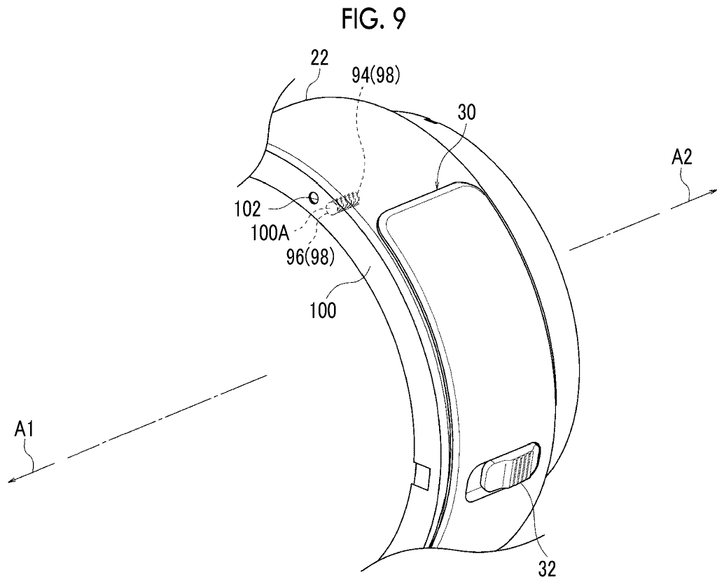

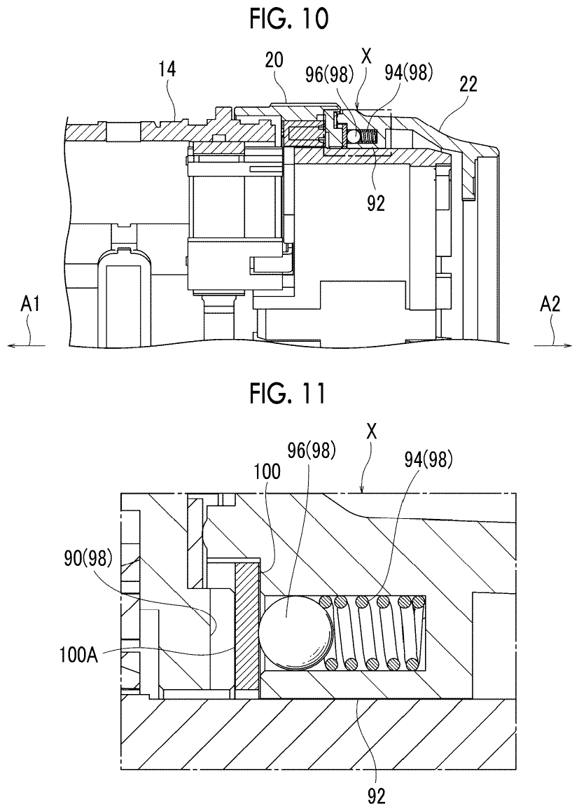

As shown in FIGS. 9 to 11, in a case where the slide switch 32 is moved to a second movement position on a side opposite to the first movement position, the rotational position of the switching member 100 becomes the second position different from the first position, and a region other than the opening 102 (hereinafter, referred to as a “closing portion 100A”) in the switching member 100 is moved to the position corresponding to the ball member 96. That is, the closing portion 100A is interposed between the image formation side surface 20A of the stop ring 20 and the ball member 96. The closing portion 100A is an example of an “intervening portion” according to the technology of the present disclosure.

In a state in which the closing portion 100A is moved to the position corresponding to the ball member 96, the ball member 96 comes into contact with the closing portion 100A from the side opposite to the image formation side surface 20A of the stop ring 20 (that is, the image formation side) (hereinafter, referred to as a “second state”). In the second state, even in a case where the stop ring 20 rotates, the ball member 96 is not fitted into the recessed portion 90 because the ball member 96 is maintained in a state of being in contact with the closing portion 100A, thereby preventing a click feeling from being imparted to the rotation of the stop ring 20.

In this manner, in the present embodiment, the switching member 100 rotates in the direction around the optical axis in conjunction with the movement of the slide switch 32 in the optical axis direction, thereby switching the mode of the click feeling imparted by the click mechanism 98. For example, in a case where a video is captured by an imaging apparatus on which the lens device 10 is mounted, it is desirable that a click sound accompanied by the click feeling is not generated. Therefore, in a case where a video is captured, the slide switch 32 need only be moved to the second movement position.

In the present embodiment, the presence or absence of the click feeling is switched, but the strength of the click feeling may also be switched. For example, the strength of the click feeling may be realized by the following structure. That is, the switching member 100 may have a first opening and a second opening with different opening areas formed side by side in the direction around the optical axis, and the ball member 96 may be selectively inserted into the first opening or the second opening depending on the rotational position of the switching member 100. Furthermore, a first protrusion amount of the ball member 96 protruding from the first opening in a state where the ball member 96 is inserted into the first opening is different from a second protrusion amount of the ball member 96 protruding from the second opening in a state where the ball member 96 is inserted into the second opening, so that a surface pressure in fitting between the ball member 96 and the recessed portion 90 is different between a state where the ball member 96 is inserted into the first opening and a state where the ball member 96 is inserted into the second opening, and the strength of the click feeling may be switched.

### Configuration of Switch Assembly 30 and Interlocking Mechanism 38

As shown in FIG. 12, the switch assembly 30 comprises a case 34, a cover 36, and the interlocking mechanism 38. The switch assembly 30 is configured to be separate from the rear cover 22 (see FIGS. 1 and 3). The case 34 is disposed on an inner peripheral side of the rear cover 22, and the cover 36 is disposed on an outer peripheral side of the rear cover 22. The interlocking mechanism 38 is supported by the cover 36. The interlocking mechanism 38 is accommodated in the cover 36.

As shown in FIG. 13, the interlocking mechanism 38 couples the slide switch 32 and the switching member 100, and converts the movement of the slide switch 32 in the optical axis direction into the movement of the switching member 100 in the direction around the optical axis. In FIG. 13, the cover 36 is not shown.

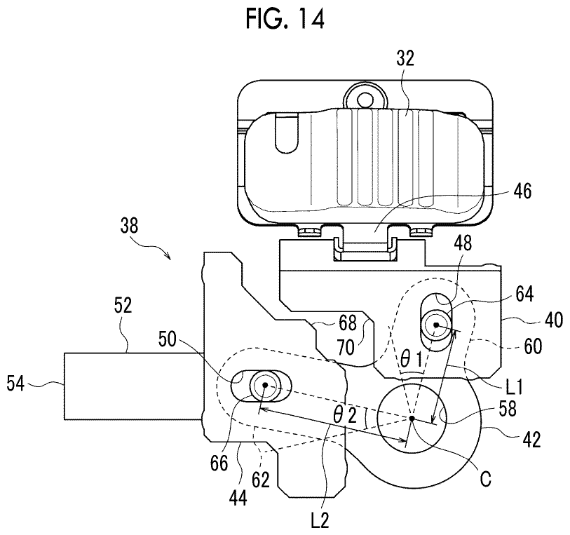

As shown in FIG. 14, the interlocking mechanism 38 comprises a first member 40, a second member 42, and a third member 44. The first member 40 is coupled to the slide switch 32 via a coupling member 46. The first member 40 is formed with a first elongated hole 48 that is an elongated hole with the direction around the optical axis as a longitudinal direction. The third member 44 is formed with a second elongated hole 50 that is an elongated hole with the optical axis direction as the longitudinal direction. The third member 44 has an extending portion 52 that extends in the optical axis direction. A tip part of the extending portion 52 is formed as a locking portion 54. The switching member 100 has a locked portion 56 (see FIG. 13). The locked portion 56 is formed in a recessed shape. The third member 44 is coupled to the switching member 100 by the locking portion 54 being locked to the locked portion 56.

The second member 42 rotates about a rotation center C. The second member 42 has a rotation center portion 58, a first arm portion 60, and a second arm portion 62. The rotation center portion 58 is a portion that serves as the center of the rotation of the second member 42. The rotation center portion 58 is formed by a circular hole with the rotation center C as its center. The first arm portion 60 extends to the first elongated hole 48 side relative to the rotation center portion 58. The second arm portion 62 extends to the second elongated hole 50 side relative to the rotation center portion 58. A first coupling portion 64 is formed at a distal end portion of the first arm portion 60. A second coupling portion 66 is formed at a distal end portion of the second arm portion 62. The first coupling portion 64 and the second coupling portion 66 are formed in a shape of a cylindrical protrusion. The first coupling portion 64 is coupled to the first member 40 by engaging with the first elongated hole 48. The second coupling portion 66 is coupled to the third member 44 by engaging with the second elongated hole 50.

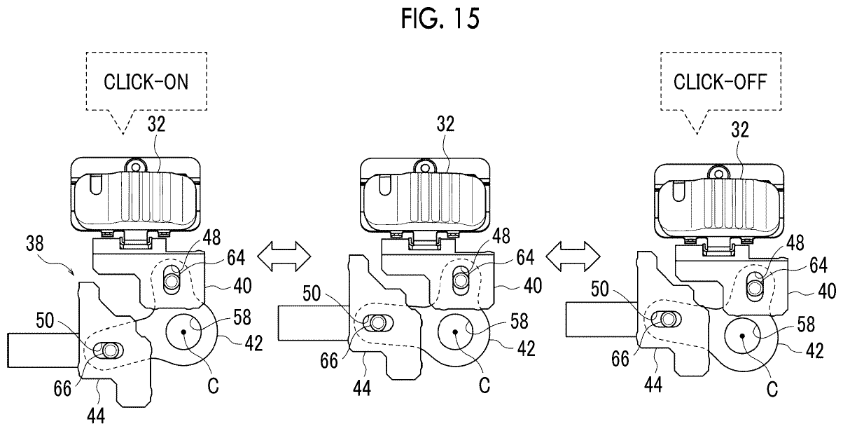

As shown in FIG. 15, in the interlocking mechanism 38, the first member 40 moves along the optical axis direction in conjunction with the movement of the slide switch 32 in the optical axis direction. In a case where the first member 40 moves along the optical axis direction, the first coupling portion 64 moves within the first elongated hole 48, so that the movement of the first member 40 in the optical axis direction is converted into the rotational motion of the second member 42. In addition, in the interlocking mechanism 38, in a case where the second member 42 rotates, the second coupling portion 66 moves within the second elongated hole 50, so that the rotational motion of the second member 42 is converted into the movement of the third member 44 in the direction around the optical axis. In a case where the third member 44 moves along the direction around the optical axis, the switching member 100 rotates in the direction around the optical axis in conjunction with the third member 44.

In the interlocking mechanism 38, in a case where the slide switch 32 moves to one side in the optical axis direction, the switching member 100 is rotated to one side in the direction around the optical axis, and, in a case where the slide switch 32 moves to the other side in the optical axis direction, the switching member 100 is rotated to the other side in the direction around the optical axis. The left side of FIG. 15 shows an aspect of the interlocking mechanism 38 in a case where a click feeling is imparted by the click mechanism 98 (that is, in a case of click-on). The right side of FIG. 15 shows an aspect of the interlocking mechanism 38 in a case where a click feeling is not imparted by the click mechanism 98 (that is, in a case of click-off). Hereinafter, the interlocking mechanism 38 and a structure surrounding the interlocking mechanism 38 will be described in more detail.

In the interlocking mechanism 38 (see FIG. 14), a first distance L1 that is a distance between the rotation center portion 58 and the first coupling portion 64 (more specifically, a distance between the rotation center C and the center of the first coupling portion 64) is set to be shorter than a second distance L2 that is a distance between the rotation center portion 58 and the second coupling portion 66 (more specifically, a distance between the rotation center C and the center of the second coupling portion 66). In addition, in the interlocking mechanism 38, both a first stroke angle θ1 that is a stroke angle of the first coupling portion 64 about the rotation center portion 58 and a second stroke angle θ2 that is a stroke angle of the second coupling portion 66 about the rotation center portion 58 are set to be acute angles. The first stroke angle θ1 corresponds to a central angle corresponding to a movement trajectory of the first coupling portion 64 (more specifically, the center of the first coupling portion 64) in a case where the slide switch 32 is moved from an end part on one side in the optical axis direction to an end part on the other side. Similarly, the second stroke angle θ2 corresponds to a central angle corresponding to a movement trajectory of the second coupling portion 66 (more specifically, the center of the second coupling portion 66) in a case where the slide switch 32 is moved from the end part on one side in the optical axis direction to the end part on the other side.

The third member 44 has a corner portion 68 that protrudes to the first member 40 side. The first member 40 has a notched portion 70 that is notched in a direction in which the corner portion 68 protrudes. In the interlocking mechanism 38, the notched portion 70 corresponding to the corner portion 68 formed in the third member 44 is formed in the first member 40, so that the first member 40 and the third member 44 are prevented from interfering with each other.

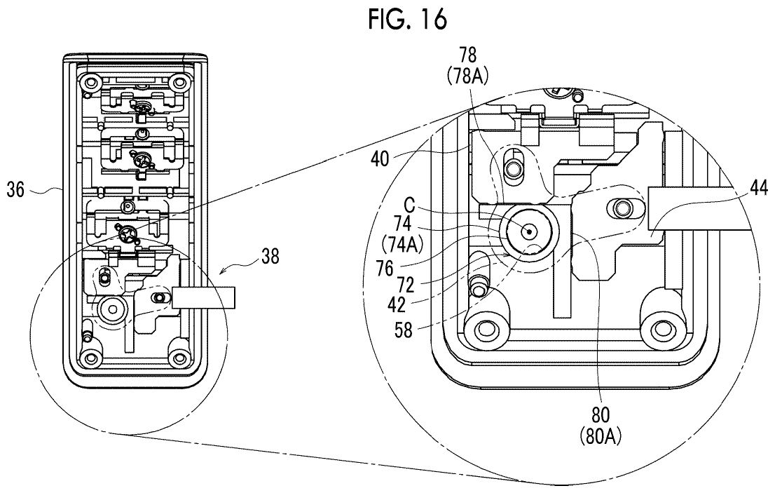

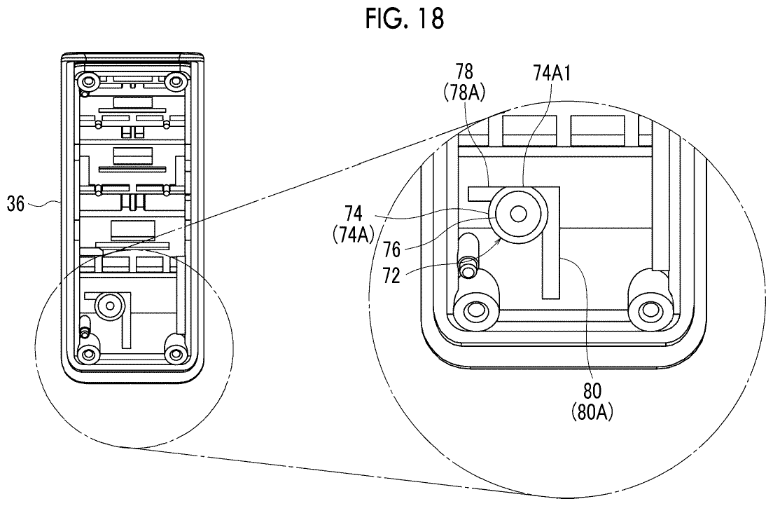

FIGS. 14 and 15 are views as seen from the outer peripheral side of the rear cover 22, whereas FIGS. 16 to 18 are views as seen from the inner peripheral side of the rear cover 22. As shown in FIGS. 16 to 18, the cover 36 has a support portion 72 that rotatably supports the second member 42. The support portion 72 has a base portion 74 that supports the second member 42 and an engaging portion 76 that is formed on a top surface of the base portion 74. The base portion 74 is formed in a cylindrical shape with the rotation center C as its center. The base portion 74 protrudes toward the inner peripheral side of the rear cover 22. The base portion 74 supports the second member 42 from the outer peripheral side of the rear cover 22 along the axis passing through the rotation center C. The engaging portion 76 is formed in a shape of a circular protrusion with the rotation center C as its center. The engaging portion 76 also protrudes toward the inner peripheral side of the rear cover 22. The engaging portion 76 is inserted into the rotation center portion 58 that is a circular hole. The engaging portion 76 is inserted into the rotation center portion 58, and the rotation center portion 58 is engaged with the engaging portion 76, so that the second member 42 is rotatably supported.

The cover 36 has a first protruding portion 78 and a second protruding portion 80. The first protruding portion 78 is formed along the optical axis direction. The second protruding portion 80 is formed along the direction around the optical axis. The first protruding portion 78 has a first sliding surface 78A that is a sliding surface on which the first member 40 slides. The first sliding surface 78A is formed by a plane that extends along the optical axis direction. The second protruding portion 80 has a second sliding surface 80A that is a sliding surface on which the third member 44 slides. The second sliding surface 80A is formed by a plane that extends along the direction around the optical axis. The first member 40 is supported to be movable in the optical axis direction by the first sliding surface 78A. The third member 44 is supported to be movable in the direction around the optical axis by the second sliding surface 80A. The base portion 74 has an outer peripheral surface 74A. The outer peripheral surface 74A is a surface of the base portion 74 around the rotation center C. A part 74A1 of the outer peripheral surface 74A forms a part of the first sliding surface 78A. That is, the outer peripheral surface 74A is curved except for the part 74A1, but the part 74A1 of the outer peripheral surface 74A is a plane that forms a part of the first sliding surface 78A.

The first protruding portion 78 and the second protruding portion 80 are integrally formed. The first protruding portion 78 and the second protruding portion 80 are integrally formed, so that the first sliding surface 78A and the second sliding surface 80A are integrally formed.

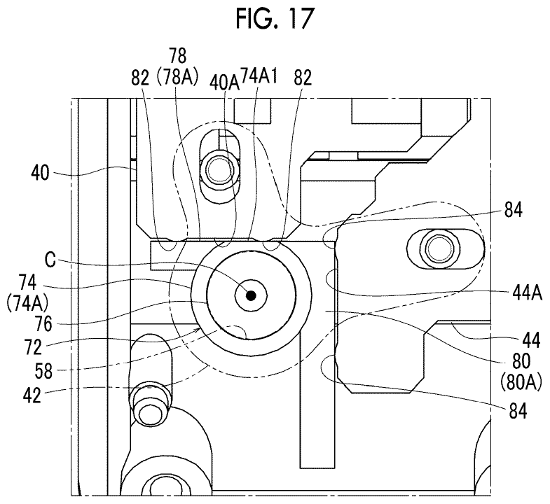

The first member 40 has a plurality of first protrusion portions 82 that slide on the first sliding surface 78A. The plurality of first protrusion portions 82 are formed to be spaced apart from each other in the optical axis direction. The first protrusion portions 82 protrude to the first sliding surface 78A side and abut against the first sliding surface 78A. The first member 40 has a first facing surface 40A that faces the first sliding surface 78A. A surface of the first facing surface 40A other than the first protrusion portions 82 is spaced apart from the first sliding surface 78A. In the example shown in FIG. 17, the number of the first protrusion portions 82 is two, but the number of the first protrusion portions 82 may be any number.

The third member 44 has a plurality of second protrusion portions 84 that slide on the second sliding surface 80A. The plurality of second protrusion portions 84 are formed to be spaced apart from each other in the direction around the optical axis. The second protrusion portions 84 protrude to the second sliding surface 80A side and abut against the second sliding surface 80A. The third member 44 has a second facing surface 44A that faces the second sliding surface 80A. A surface of the second facing surface 44A other than the second protrusion portions 84 is spaced apart from the second sliding surface 80A. In the example shown in FIG. 17, the number of the second protrusion portions 84 is two, but the number of the second protrusion portions 84 may be any number.

Next, the effects of the present embodiment will be described.

As described above in detail, the lens device 10 according to the present embodiment comprises the stop ring 20 that rotates in the direction around the optical axis, the click mechanism 98 that imparts a click feeling to the rotation of the stop ring 20, the slide switch 32 that moves along the optical axis direction, and the switching member 100 that switches the mode of the click feeling by the click mechanism 98 by rotating in the direction around the optical axis in conjunction with the movement of the slide switch 32. Therefore, since the switching member 100 moves along the direction around the optical axis, the lens device 10 can be reduced in size, particularly in the optical axis direction as compared with, for example, a case where a member for switching the mode of the click feeling imparted by the click mechanism 98 moves along the optical axis direction.

In addition, since the slide switch 32 moves along the optical axis direction, the operability of the slide switch 32 can be improved as compared with, for example, a case where the slide switch 32 moves along the direction around the optical axis. That is, in a case where the slide switch 32 moves along the direction around the optical axis, there is an inconvenience in that the grip on the lens device 10 needs to be switched to operate the slide switch 32, but, in a case where the slide switch 32 moves along the optical axis direction, it is unnecessary to switch the grip on the lens device 10 to operate the slide switch 32.

In addition, the lens device 10 comprises the first member 40 that is coupled to the slide switch 32 and that moves along the optical axis direction, the second member 42 that is coupled to the first member 40 and that converts the movement of the first member 40 into a rotational motion, and the third member 44 that is coupled to the second member 42 and that moves in the direction around the optical axis in conjunction with the rotational motion of the second member 42. The switching member 100 is coupled to the third member 44. As a result, the switching member 100 can be rotated in the direction around the optical axis in conjunction with the movement of the slide switch 32.

In addition, the second member 42 has the rotation center portion 58 serving as the center of the rotation of the second member 42, the first coupling portion 64 that is coupled to the first member 40, and the second coupling portion 66 that is coupled to the third member 44. The first distance L1 that is a distance between the rotation center portion 58 and the first coupling portion 64 is shorter than the second distance L2 that is a distance between the rotation center portion 58 and the second coupling portion 66. As a result, a movement distance of the third member 44 along the direction around the optical axis can be made longer than a movement distance of the first member 40 along the optical axis direction. That is, the third member 44 can have a long movement distance with a short movement distance of the first member 40. As a result, the operability of switching the mode of the click feeling using the slide switch 32 can be improved as compared with a case where the first distance L1 and the second distance L2 are the same or a case where the first distance L1 is longer than the second distance L2.

In addition, both the first stroke angle θ1 that is a stroke angle of the first coupling portion 64 about the rotation center portion 58 and the second stroke angle θ2 that is a stroke angle of the second coupling portion 66 about the rotation center portion 58 are acute angles. As a result, for example, the movement distance of the slide switch 32 can be reduced as compared with a case where both the first stroke angle θ1 and the second stroke angle θ2 are obtuse angles, so that the operability of switching the mode of the click feeling using the slide switch 32 can be improved. In addition, for example, the movement distance of the first member 40 and the movement distance of the second member 42 can be reduced as compared with a case where both the first stroke angle θ1 and the second stroke angle θ2 are obtuse angles, so that the interlocking mechanism 38 and the switch assembly 30 can be reduced in size.

In addition, the second member 42 has the first arm portion 60 that extends from the rotation center portion 58 toward the first coupling portion 64 and the second arm portion 62 that extends from the rotation center portion 58 toward the second coupling portion 66. That is, the second member 42 is formed in an L-shape having the first arm portion 60 and the second arm portion 62. As a result, for example, the second member 42 and the interlocking mechanism 38 can be reduced in size as compared with a case where the second member 42 has a shape (for example, a circular shape) other than the L-shape.

In addition, the lens device 10 comprises the switch assembly 30. The switch assembly 30 has the slide switch 32, the first member 40, the second member 42, and the third member 44. Therefore, the slide switch 32, the first member 40, the second member 42, and the third member 44 can be assembled to the switch assembly 30, and then the switch assembly 30 can be assembled to the rear cover 22. As a result, the ease of assembly of the lens device 10 can be improved as compared with a case where the slide switch 32, the first member 40, the second member 42, and the third member 44 need to be individually assembled to the rear cover 22.

In addition, the second member 42 has the rotation center portion 58 serving as the center of the rotation of the second member 42, and the switch assembly 30 has the support portion 72 that rotatably supports the second member 42. The support portion 72 has the base portion 74 that supports the second member 42 and the engaging portion 76 that is formed on a top surface of the base portion 74 and that is engaged with the rotation center portion 58. The part 74A1 of the outer peripheral surface 74A of the base portion 74 forms a part of the first sliding surface 78A on which the first member 40 slides. As a result, as compared with a case where the part 74A1 of the outer peripheral surface 74A does not form a part of the first sliding surface 78A, that is, a case where the outer peripheral surface 74A of the base portion 74 is spaced apart from the first sliding surface 78A in the direction around the optical axis, the interlocking mechanism 38 and the switch assembly 30 can be reduced in size. That is, since the part 74A1 of the outer peripheral surface 74A forms a part of the first sliding surface 78A on which the first member 40 slides, the interlocking mechanism 38 and the switch assembly 30 can be reduced in size.

In addition, the switch assembly 30 has the first sliding surface 78A on which the first member 40 slides and the second sliding surface 80A on which the third member 44 slides. The first sliding surface 78A and the second sliding surface 80A are integrally formed. As a result, since the first sliding surface 78A and the second sliding surface 80A form a bent surface, the rigidity of the first sliding surface 78A and the second sliding surface 80A can be improved as compared with, for example, a case where the first sliding surface 78A and the second sliding surface 80A are separately formed. In addition, the switch assembly 30 can be reduced in size as compared with a case where the first sliding surface 78A and the second sliding surface 80A are separately formed.

In addition, the first member 40 has the first protrusion portion 82 that slides on the first sliding surface 78A. As a result, as compared with a case where the first protrusion portion 82 is not present, that is, a case where the first facing surface 40A of the first member 40 slides on the first sliding surface 78A, the sliding resistance of the first member 40 can be reduced. Similarly, the third member 44 has the second protrusion portion 84 that slides on the second sliding surface 80A. As a result, as compared with a case where the second protrusion portion 84 is not present, that is, a case where the second facing surface 44A of the third member 44 slides on the second sliding surface 80A, the sliding resistance of the third member 44 can be reduced. As a result, since the interlocking mechanism 38 operates smoothly, the resistance of the slide switch 32 can be reduced, thereby improving the operability of the slide switch 32.

In addition, the switch assembly 30 has the cover 36 that accommodates the first member 40, the second member 42, and the third member 44. As a result, since the first member 40, the second member 42, and the third member 44 are not exposed to the outside of the switch assembly 30, the appearance design of the switch assembly 30 and the lens device 10 can be improved as compared with a case where the first member 40, the second member 42, and the third member 44 are exposed to the outside of the switch assembly 30.

In addition, the lens device 10 comprises the stop ring 20. The structure for switching the mode of the click feeling imparted by the click mechanism 98 is applied to the stop ring 20. As a result, for example, in a case where a video is captured by an imaging apparatus on which the lens device 10 is mounted, even in a case where the stop ring 20 is operated, the click sound accompanied by the click feeling can be suppressed by switching the mode of the click feeling.

In addition, the click mechanism 98 has the plurality of recessed portions 90 that are formed on the image formation side surface 20A of the stop ring 20 and that are arranged in the direction around the optical axis, the ball member 96 that faces the surface 20A, and the spring 94 that biases the ball member 96 to the surface 20A side. The switching member 100 has the opening 102 for selectively fitting the ball member 96 into the plurality of recessed portions 90 in a case where the position of the slide switch 32 is the first position, and the closing portion 100A that is interposed between the surface 20A and the ball member 96 in a case where the position of the slide switch 32 is the second position. As a result, by switching the position of the slide switch 32, the mode of the click feeling can be switched between a case where the click feeling is present and a case where the click feeling is not present.

In addition, the plurality of recessed portions 90, the ball member 96, and the spring 94 constitute a locking mechanism that locks the stop ring 20. As a result, it is possible to prevent the stop ring 20 from being unintentionally rotated as compared with a case where the locking mechanism is not provided.

In the present embodiment, the structure for switching the mode of the click feeling imparted by the click mechanism 98 is applied to the stop ring 20, but may be applied to an operation ring (for example, the focus ring 16 or the zoom ring 18) other than the stop ring 20.

In addition, in the present embodiment, the slide switch 32 that is a slide-type switch is used as the operation member for switching the mode of the click feeling imparted by the click mechanism 98, but a switch of a method (for example, a toggle type) other than the slide type may be used.

The content of the above description and the content of the drawings are detailed explanations of the parts relating to the technology of the present disclosure, and are merely examples of the technology of the present disclosure. For example, description related to the above configurations, functions, actions, and effects is description related to an example of configurations, functions, actions, and effects of the parts relating to the technology of the present disclosure. Thus, it is needless to say that unnecessary portions may be deleted, new elements may be added, or replacement may be made to the content of the above description and the content of the drawings without departing from the gist of the technology of the present disclosure. In order to avoid complication and easily understand the parts relating to the technology of the present disclosure, in the content of the above description and the content of the drawings, the description regarding common general technical knowledge which is not necessarily particularly described in terms of embodying the technology of the present disclosure is omitted.

What is claimed is:

1. A lens device comprising:
an operation ring that rotates in a direction around an optical axis;
a click mechanism that imparts a click feeling to the rotation of the operation ring;
an operation member that moves along a direction of the optical axis; and
a switching member that switches a mode of the click feeling imparted by the click mechanism by rotating in the direction around the optical axis in conjunction with the movement of the operation member.

2. The lens device according to claim 1, further comprising:
a first member that is coupled to the operation member and that moves along the direction of the optical axis;
a second member that is coupled to the first member and that converts the movement of the first member into a rotational motion; and
a third member that is coupled to the second member and that moves along the direction around the optical axis in conjunction with the rotational motion of the second member,
wherein the switching member is coupled to the third member.

3. The lens device according to claim 2,
wherein the second member includes
a rotation center portion serving as a center of rotation of the second member,
a first coupling portion that is coupled to the first member, and
a second coupling portion that is coupled to the third member, and
a first distance that is a distance between the rotation center portion and the first coupling portion is shorter than a second distance that is a distance between the rotation center portion and the second coupling portion.

4. The lens device according to claim 3,
wherein both a first stroke angle that is a stroke angle of the first coupling portion about the rotation center portion and a second stroke angle that is a stroke angle of the second coupling portion about the rotation center portion are acute angles.

5. The lens device according to claim 3,
wherein the second member includes
a first arm portion that extends from the rotation center portion toward the first coupling portion, and
a second arm portion that extends from the rotation center portion toward the second coupling portion.

6. The lens device according to claim 2, further comprising:
a switch assembly,
wherein the switch assembly includes the operation member, the first member, the second member, and the third member.

7. The lens device according to claim 6,
wherein the second member includes a rotation center portion serving as a center of rotation of the second member,
the switch assembly includes a support portion that rotatably supports the second member,
the support portion includes
a base portion that supports the second member, and
an engaging portion formed on a top surface of the base portion and engaged with the rotation center portion, and
a part of an outer peripheral surface of the base portion forms a part of a first sliding surface on which the first member slides.

8. The lens device according to claim 6,
wherein the switch assembly includes
a first sliding surface on which the first member slides, and
a second sliding surface on which the third member slides, and
the first sliding surface and the second sliding surface are integrally formed.

9. The lens device according to claim 8,
wherein the first member includes a first protrusion portion that slides on the first sliding surface, and
the third member includes a second protrusion portion that slides on the second sliding surface.

10. The lens device according to claim 6,
wherein the switch assembly includes a cover that accommodates the first member, the second member, and the third member.

11. The lens device according to claim 1,
wherein the operation ring is a stop ring.

12. The lens device according to claim 1,
wherein the click mechanism includes
a plurality of recessed portions that are formed on a first surface of the operation ring and that are arranged in the direction around the optical axis,
a protruding member that faces the first surface, and
a biasing member that biases the protruding member to a first surface side, and
the switching member includes
an opening for selectively fitting the protruding member into the plurality of recessed portions in a case where a position of the operation member is a first position, and
an intervening portion that is interposed between the first surface and the protruding member in a case where the position of the operation member is a second position.

13. The lens device according to claim 12,
wherein the plurality of recessed portions, the protruding member, and the biasing member constitute a locking mechanism that locks the operation ring.
